(19) United States
(12) Patent Application Publication
(10) Pub. No.: US 2022/0392280 A1
(43) Pub. Date: Dec. 8, 2022

(54) FAULT MANAGEMENT SYSTEM FOR FUNCTIONAL SAFETY OF AUTOMOTIVE GRADE CHIP

(71) Applicant: Nanjing SemiDrive Technology Ltd., Nanjing (CN)

(72) Inventors: Bin WEI, Nanjing (CN); Lihang ZHANG, Nanjing (CN); Bin LI, Nanjing (CN)

(73) Assignee: Nanjing SemiDrive Technology Ltd., Nanjing (CN)

(21) Appl. No.: 17/891,501

(22) Filed: Aug. 19, 2022

Related U.S. Application Data
(63) Continuation of application No. PCT/CN2021/076492, filed on Feb. 10, 2021.

(30) Foreign Application Priority Data
Feb. 20, 2020 (CN) 202010103727.8

(51) Int. Cl. G07C 5/08; G06F 11/07

(52) U.S. Cl. CPC G07C 5/0808; G06F 11/0769; G06F 11/0733

(57) ABSTRACT

A fault management system for functional safety of an automotive grade chip includes: an out-of-chip system and an automotive-grade chip, where the automotive-grade chip includes a processor, a system controller, a system configuration module, a fault management device, and an on-chip function module; and the fault management device is configured with a fault classification management model.

### CROSS-REFERENCE TO RELATED APPLICATIONS

This application is a continuation of International Application No. PCT/CN2021/076492, filed on Feb. 10, 2021, which claims priority to Chinese Patent Application No. 202010103727.8, filed on Feb. 20, 2020. Both applications are incorporated herein by reference in their entireties.

### TECHNICAL FIELD

This application relates to a fault management system for a road vehicle, and in particular, to a fault management system for functional safety of an automotive grade chip.

### BACKGROUND

Functional safety is crucial to safety-related electronic and electrical systems such as power control systems in the automotive field. Application of the functional safety can impose a strict restriction on a system, to ensure the system to be performed safely and reliably in a complex system environment.

Many safety mechanisms are integrated in an automotive-grade chip. The safety mechanisms may include a safety mechanism in an IP (a designed module inside the chip) and a system-level safety mechanism. However, a current automotive-grade chip has a great load in fault identification, classification, handling, and the like, and the current automotive-grade chip cannot take reasonable fault response measures in an effective and timely manner, such that the availability of the system when a fault occurs is reduced.

### SUMMARY

In view of this, this application provides a fault management system for functional safety of an automotive grade chip. By using a centralized, hierarchical, and fine-grained chip function fault management system, the fault management system can effectively detect and classify internal faults of the chip according to severity levels, such that the fault management system can provide the system with accurate fault information, and ensure that system software accurately locates and responds to various faults. Therefore, a fault detection load of the system software is reduced, reasonable fault response measures are taken in an effective and timely manner, and availability of the system is improved when a fault occurs.

A first aspect of this application provides a fault management system for functional safety of an automotive grade chip, and the fault management system includes an out-of-chip system and an automotive-grade chip; the automotive-grade chip further includes a processor (CPU), a system controller, a system configure module, a fault management device, and on-chip function modules (IP1, . . . , and IPn). The fault management device is configured with a fault classification management model.

In the first aspect of this application, the fault management device further includes a fault injector, a static signal monitor, and a fault controller.

The fault injector is electrically connected to each of the function modules (IP1, . . . , and IPn) inside the chip, and each of the function modules (IP1, . . . , and IPn) is internally configured with at least one safety mechanism.

The fault controller is electrically connected to each of the IPs (IP1, . . . , and IPn), the static signal monitor, the processor (CPU), the system controller, and the out-of-chip system separately.

The static signal monitor is electrically connected to the system configure module inside the chip.

In the first aspect of this application, the fault injector further performs fault injection on all the function modules (IP1, . . . , and IPn) or the at least one safety mechanism of the system by using error injection signals, detects a corresponding fault indication signal, and determines whether the at least one safety mechanism itself fails.

In the first aspect of this application, the fault controller is further responsible for collecting fault indicated signals sent by all safety mechanisms in a static signal monitor of the fault controller, each IP inside the chip, and the system of the chip.

In the first aspect of this application, the static signal monitor further performs real-time monitoring on the static signals generated by the system configure module inside the chip, and failures caused by signal stuck-at faults can be avoided.

In the first aspect of this application, a fault indication signal generated by the static signal monitor is further output to the fault controller for classification processing.

A second aspect of this application further provides a fault management device for functional safety of an automotive grade chip, where the fault management device includes a fault injector, a static signal monitor, and a fault controller.

The fault injector is electrically connected to all function modules (IP1, . . . , and IPn) inside the chip, and each of the function modules (IP1, . . . , and IPn) is internally configured with at least one safety mechanism.

The fault controller is electrically connected to each of the IPs (IP1, . . . , and IPn), the static signal monitor, a processor (CPU), a system controller, and an out-of-chip system separately. The fault controller is internally provided with a fault classification management model, and the fault classification management model is composed of four types of faults.

The static signal monitor is electrically connected to a system configure module inside the chip.

In the second aspect of this application, the four types of faults are further configured with the following rules: type 1: a fault that needs to be handled with assistance of an out-of-chip system is classified as a fail fatal; type 2: a fault that results in a failure of a main function is classified as fail safe; type 3: a fault handled through adaptive degradation operation is classified as fail operational; and type 4: a fault handled through automatic error correction operation is classified as a fail correctable.

In the second aspect of this application, severity levels of the four types of faults are further configured with the following rules: rule 1: type 1>type 2>{type 3, type 4}, where {type 3, type 4} denotes a set of type 3 and type 4; rule 2: type 3>type 4; and rule 3: rule 1>rule 2.

In the second aspect of this application, the fault controller further generates, based on pre-configuration and according to different scenarios where the chip is applied and the fault types, fault information of a four-level structure composed of the four types of faults.

In the second aspect of this application, the fault controller further includes four fault selections, and a plurality of correspondences can be formed between the fault information generated by the fault controller and the fault indication signals input by the safety mechanisms by configuration of the fault selections.

In the second aspect of this application, the plurality of correspondences further include a one-to-one (1 to 1) correspondence, a one-to-many (1 to N) correspondence, and/or a many-to-one (N to 1) correspondence, so as to be adapted to different application scenarios and different functional safety level requirements.

The fault management system for functional safety of an automotive grade chip provided in this application can ensure, by using a fine-grained fault classification system, that system software accurately locates and responds to various faults, and that reasonable fault response measures are taken in an effective and timely manner, such that the availability of the system when a fault occurs can be improved. In addition, a fault detection load of the system software is reduced, facilitating implementation of fast, high-coverage, and individually configurable power-on self-test and power-down self-test by the chip.

Additional aspects and advantages of this application will be given partially in the following descriptions, and become more apparent from the following descriptions, or be understood through practice of this application.

### BRIEF DESCRIPTION OF THE DRAWINGS

FIG. 1 is a schematic diagram of a four-level fault classification management model designed according to severity levels of chip function faults according to an implementation of this application.

FIG. 2 is a flowchart of logical application of a four-level fault classification management model (F4CM) according to an implementation of this application.

FIG. 3 is a flowchart of logical application of a four-level fault classification management model (F4CM) according to another implementation of this application.

FIG. 4 is a logical structural diagram of a fault controller according to an implementation of this application.

FIG. 5 is a logical structural diagram of a fault management system for functional safety of an automotive grade chip according to an implementation of this application.

### DETAILED DESCRIPTION OF THE EMBODIMENTS

Implementations of this application will be described in detail below. Examples of the implementations are shown in the accompanying drawings, in which the same or similar reference signs indicate the same or similar elements or elements having the same or similar functions. The implementations described below with reference to the accompanying drawings are exemplary, and are used merely to explain this application and shall not be understood as a limitation to this application.

Those skilled in the art can understand that a related module mentioned in this application is a hardware device for performing one or more of steps, measures, and solutions of operations, methods and processes in this application. The hardware device may be specially designed and manufactured for required purposes, or may be a known device in a general-purpose computer or another known hardware device. The general-purpose computer is selectively activated or reconfigured by a program stored in the computer.

It can be understood by those skilled in the art that the singular forms “a”, “an”, “the” and “said” may also encompass plural forms, unless otherwise stated. It should be further understood that the expression “include/comprise” used in the description of this application means there is a feature, an integer, a step, an operation, an element and/or a component, but could not preclude existing or adding of one or more other features, integers, steps, operations, elements, components and/or groups thereof. It should be understood that when an element is “connected” or “coupled” to another element, it may be directly connected or coupled to the another element, or there may be an intermediate element. In addition, “connected” or “coupled” as used herein may include a wireless connection or a wireless coupling. The expression “and/or” as used herein includes all or any one of one or more of relevant listed items or all combinations thereof.

Those skilled in the art can understand that all terms (including technical and scientific terms) as used herein have the same meanings as commonly understood by those of ordinary skill in the art of this application, unless otherwise defined. It should be further understood that terms such as those defined in the general dictionary should be understood to have the meanings consistent with the meanings in the context of the prior art, and will not be interpreted in an idealized or overly formal meaning unless specifically defined as herein.

Design of automotive functional safety generally follows the standard ISO (International Organization for Standardization) 26262 (a standard for the automotive industry first released in 2011 and revised in 2018), and the standard ISO 26262 is a derivation of the basic functional safety standard IEC (International Electrotechnical Commission) 61508 (first released in 1998 and last revised in 2010) for electronic, electrical, and programmable devices. The standard ISO 26262 is an international standard for mainly focusing on the components special for the automotive field in the automotive industry, and aiming to improve the functional safety of automotive electronic and electrical products. For example, the components can be specific electrical devices, electronic devices, programmable electronic devices, and the like.

The standard ISO 26262 adopts a hazard analysis and risk assessment (HARA for short) and V model design architecture to obtain consistent analysis results for functional safety requirement levels. The standard ISO 26262 is implemented through capability maturity model integration processes such as design development, verification, validation, and the like. The standard ISO 26262 classifies a system or a component of the system into required automotive safety integrity levels (ASIL for short) according to a degree of safety risk, to enable functional safety of products to meet the automotive safety requirements. There are four ASILs: ASIL A, ASIL B, ASIL C, and ASIL D in ascending order, where ASIL A indicates the lowest level and ASIL D indicates the highest level. At least one safety goal is determined for each hazard. The safety goal is the highest-level safety requirement for a system. A system-level safety requirement is derived from the safety goal and is then assigned to hardware and software. The ASILs determine requirements for safety of a system. A higher ASIL indicates a higher requirement for the safety of the system, a higher cost paid for achieving the safety, larger diagnostic coverage of hardware, a stricter development process, correspondingly the development costs are increased, the development cycle is extended, and the technical requirement is more stringent. For example, the functional safety standard ISO 26262 requires that a single-point fault metric (SPFM for short) is greater than or equal to 99%, such that the highest safety integration level ASIL D can be reached. Therefore, it may be complicated and difficult for real-time systems to achieve functional safety.

To fulfill ASIL requirements, many safety mechanisms are integrated in an automotive-grade chip. These safety mechanisms may include a safety mechanism in an IP (a designed module inside a chip) and a system-level safety mechanism. When a fault occurs and is detected by a corresponding safety mechanism, the safety mechanism needs to report the occurrence of the fault in a timely manner, so that the system can give a corresponding response to the fault according to a type and degree of the fault, thereby avoiding the fault being latent or a function failure directly caused by the fault.

However, there are usually some problems in design of current automotive-grade chips with functional safety requirements. These problems are as follows.

For example, in a case that a centralized fault management module inside a chip is lack, there is a great load to fault identification, classification and handling of system software, which goes against implementation of fast, high-coverage, and individually configurable power-on self-test and power-down self-test by the chip.

For example, in a case where a fault management module is integrated in a chip, faults are classified with a large granularity (these faults are classified into two types: fatal fault and error fault), which makes a system fail to take reasonable fault response measures in an effective and timely manner, and the availability of the system when a fault occurs is reduced.

Therefore, an existing fault management system for functional safety of an automotive grade chip needs to be optimized, to effectively resolve the foregoing two problems.

Embodiments of this application provide a fault management system for functional safety of an automotive grade chip. The fault management system includes an out-of-chip system and an automotive-grade chip. The automotive-grade chip includes a fault management device. The fault management device is configured with a fault classification management model. According to the fault management system for functional safety of an automotive grade chip, it can be ensured, through a fine-grained fault classification system, that system software accurately locates and responds to various faults by using the fault management device configured with the fault classification management model, such that reasonable fault response measures are taken in an effective and timely manner, and the availability of the system when a fault occurs is improved.

For example, in the embodiments of this application, the automotive-grade chip may further include a processor (CPU), a system controller, a system configure module, on-chip function modules (IP1, . . . , and IPn), and the like.

A fault management system for functional safety of an automotive grade chip according to at least one embodiment of this application is described below in detail with reference to the accompanying drawings.

It should be noted that, in some embodiments of this application, “application scenario” refers to an application scenario in a vehicle to which a chip (automotive-grade chip) is applied, which mainly involves an environment composed of different systems or components in the vehicle. A safety mechanism in an IP and a system-level safety mechanism are integrated in the automotive-grade chip, in an event that a fault occurs and is detected by a corresponding safety mechanism, the safety mechanism needs to report the occurrence of the fault in a timely manner, so that a system can give a corresponding response to the fault according to a type and degree of the fault, thereby avoiding the fault being latent or a function failure directly caused by the fault.

In the embodiments of this application, random hardware faults inside a chip can be distinguished according to the following dimensions (W1 to W3).

W1. External assistance: whether the faults need to be handled with assistance of an out-of-chip system after the fault occurs;

W2. Main function: whether a main function of hardware in a chip or a software system running on the chip fails after a fault occurs; and

W3. Automatic handling: whether the main function of hardware inside a chip or a software system running on the chip can automatically handle the fault after it occurs. This dimension can be subdivided into degradation operation and automatic error correction.

Based on the above analysis results, in the embodiments of this application, the following definitions (Definition 1 to Definition 4) are provided.

Definition 1: a fault that needs to be handled with assistance of an out-of-chip system is defined as a fail fatal;

Definition 2: a fault that results in a failure of a main function is defined as fail safe;

Definition 3: a fault handled through adaptive degradation operation is defined as fail operational.

Definition 4: a fault handled through automatic error correction operation is defined as a fail correctable;

According to the foregoing dimensional logic and theory, in at least one embodiment of this application, the following fault classification management system is established. For details, see Table 1.

TABLE 1
Fault classification management system

| Fault | | |
|---|---|---|
| Level | Fault Name | Fault Description |
| 1 | Fail Fatal | A fault that cannot be automatically handled by |
| | | hardware inside a chip or a software system |
| | | running on the chip and needs to be handled |
| | | with assistance of an out-of-chip system to |
| | | enter a safe state or resume operation |
| 2 | Fail Safe | A fault that results in a function failure but is |
| | | handled in a manner that the hardware inside |
| | | the chip or the software system running on the |
| | | chip can automatically enter a safe state or |
| | | resume operation |
| 3 | Fail Operational | A fault handled through degradation operation |
| | | of a main function |
| 4 | Fail Correctable | A fault resulting in an error that can be |
| | | automatically corrected by a safety mechanism |
| | | inside the chip to avoid a failure after the fault |
| | | occurs |

For example, in the embodiments of this application, faults of all the function modules (IP1, . . . , and IPn) inside the automotive-grade chip can be classified into the four types listed in Table 1 (fault levels 1 to 4 respectively correspond to types 1 to 4). Table 1 may be used in engineering practice to classify and mark random hardware faults inside a chip, so that a system can automatically determine a type of the fault and accurately locate the fault.

In the embodiments of this application, it can be learned from the engineering practice in the art that, according to analysis on severity levels of chip function faults, there is a rule logic (rule 1 to rule 3) as follows.

Rule 1: external assistance (type 1)>main function loss (type 2)>automatic handling {type 3, type 4}, and {type 3, type 4} denotes a set of type 3 and type 4;

Rule 2: degradation operation (type 3)>automatic error correction (type 4); and

Rule 3: rule 1>rule 2.

In rule 3, type 1>type 2>type 3, and type 1>type 2>type 4.

Compared with a current chip function fault classification model meeting the ASIL standard, the fault classification provided in the embodiments of this application has at least the following main advantages (advantages 1 to 5).

Advantage 1: a centralized fault classification system. Various situations of chip function faults are covered by the four types of faults, so that a quick response can be made during subsequent fault handling according to different four types, and the fault handling response efficiency can be improved.

Advantage 2: a fine-grained fault classification system. Fault types are subdivided from currently common fatal and error faults to the foregoing four types (type 1 to type 4), which improves a classification granularity. Therefore, software or hardware can directly perform corresponding handling, and the fault response speed can be increased.

Advantage 3: a hierarchical fault classification system. The four fault levels (for example, the above-mentioned four levels of A, B, C and D) are highly in accordance with functional safety requirements, which facilitates the development of functional safety-related systems.

Advantage 4: a reduced fault detection load of system software. The classification granularity becomes finer, so that the software or hardware can directly performs corresponding handling, the fault response speed can be increased, and the fault classification is directly completed by the hardware, which reduces a burden of the software.

Advantage 5: an individually configurable application scenario. A fault classification method can be customized to fulfill different application scenarios, and the flexibility of chip application can be improved.

FIG. 2 is a flowchart of logical application of a four-level fault classification management model (F4CM) according to an implementation of this application.

In some embodiments of this application, as shown in FIG. 2, the fault management device can perform the following steps S2-1 to S2-4.

Step S2-1: detecting a function fault that occurs on an IP inside a chip, that is, receiving a fault indication signal sent by at least one safety mechanism.

Step S2-2: determining, according to the four-level fault classification management model (F4CM), whether the faults need to be handled with assistance of an out-of-chip system after the function fault occurs on the IP; and if a determining result is “yes”, determining the fault as the fail fatal, and outputting information of the signal for the function fault (Fail Fatal) of the IP to an out-of-chip system, where the out-of-chip system assists in performing resetting, powering-off, or other necessary operations; or if a determining result is “no”, performing a next determining step (Step 2-3 shown below) according to the four-level fault classification management model (F4CM).

Step 2-3, determining whether a main function of hardware inside the chip or a software system running on the chip fails after the fault occurs.

According to Step 2-3, if a determining result is “yes”, determining the fault as the fail safe, and outputting information of the signal for the function fault (Fail Safe) of the IP to a system controller inside the chip, to perform automatic resetting or another necessary operation to enable the system to enter a safe state or resume operation; or if a determining result is “no”, performing a next determining step (Step 2-4 shown below) according to the four-level fault classification management model (F4CM).

Step 2-4, determining whether a main function of hardware inside the chip or a software system running on the chip requires degradation operation after the fault occurs.

According to Step S2-4, if a determining result is “yes”, determining the fault as the fail operational, and outputting information of the signal for the function fault (Fail Operational) of the IP to a processor (CPU) inside the chip, to perform degradation operation by software running on the CPU; or if a determining result is “no”, determining the fault as a fail correctable, and outputting information of the signal for the function fault (Fail Correctable) of the IP to a processor (CPU) inside the chip, to perform automatic error correction by a safety mechanism of software running on the CPU or by a safety mechanism in the IP.

For example, in the embodiments of this application, a level to which a fault belongs is determined in ascending order of the four levels of the fault management system, and during execution, faults are handled in ascending order. In this way, a process of handling a relatively severe fault can be accelerated, and response time for handling the fault can be shortened. It should be noted that, a classification standard of the low and high fault levels is based on the numbers listed in above Table 1, that is, a fault with the highest level is the fail correctable represented by the number 4, and a fault with the lowest level is the fail fatal represented by the number 1. The smaller number of a fault level is, the greater a severity degree of the fault is.

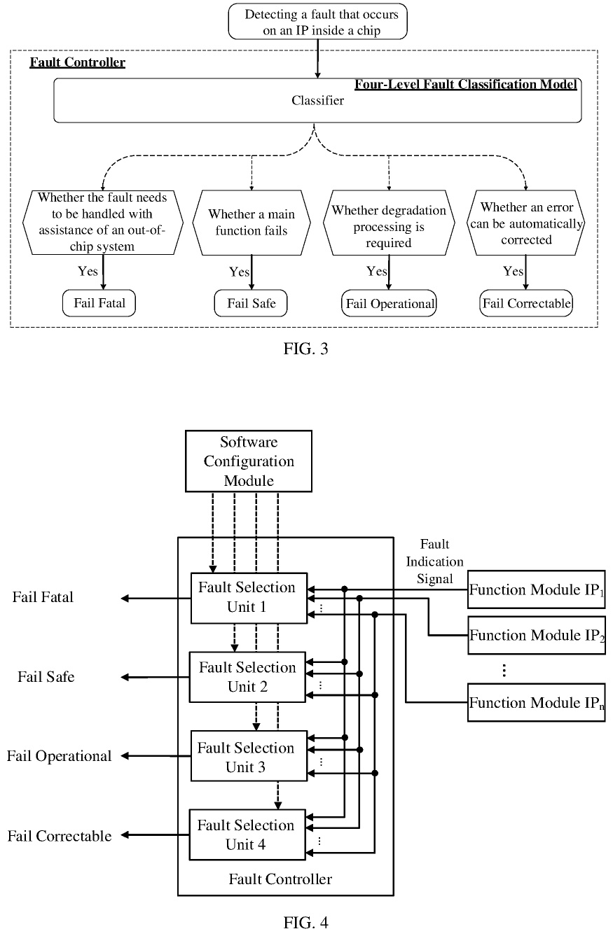

FIG. 3 is a flowchart of logical application of the four-level fault classification management model (F4CM) according to another implementation of this application.

In some other embodiments of this application, the fault management device may further include a classifier. The classifier is configured to receive a signal for a function fault that occurs on each function module inside a chip, and determine a type of the function fault. Using the classifier to pre-determine a type of a function fault can eliminate a step of logical judgment, simplify calculation, and improve processing efficiency. For example, as shown in FIG. 3, the fault management device including the classifier can perform the following steps S3-1 to S3-3. A difference between the embodiment in FIG. 3 and that in FIG. 2 lies in that in the embodiment in FIG. 3, a determining logic of the four levels of faults changes, and the classifier is used to receive a signal for a function fault that occurs on IP1, . . . , and IPn inside the chip, and determine a type of the function fault according to four different types of fault attributes. The four-level fault classification management model (F4CM) is configured in the classifier.

Step S3-1: detecting a function fault that occurs on an IP inside a chip, that is, receiving a fault indication signal sent by a safety mechanism.

Step S3-2: determining, according to the four-level fault classification management model (F4CM), the function fault that occurs on the IP belongs to which of the following four fault types: fail fatal, fail safe, fail operational, and fail correctable.

Step S3-3: in a case where the function fault is the fail fatal, outputting information of the signal for the function fault (Fail Fatal) of the IP to an out-of-chip system, where the out-of-chip system assists in performing resetting, powering-off, or other necessary operations.

Step S3-3: in a case where the function fault is the fail safe, outputting information of the signal for the function fault (Fail Safe) of the IP to a system controller inside the chip, to perform automatic resetting or another necessary operation to enable the system to enter a safe state or resume operation;

Step S3-3: in a case where the function fault is the fail operational, outputting information of the signal for the function fault (Fail Operational) of the IP to a processor (CPU) inside the chip, to perform degradation operation by software running on the chip; or

Step S3-3: in a case where the function fault is the fail correctable, outputting information of the signal for the function fault (Fail Correctable) of the IP to a processor (CPU) inside the chip, to perform automatic error correction by a safety mechanism of software running on the CPU or by a safety mechanism in the IP.

For example, in at least one embodiment of this application, in a case where the fault management device includes a classifier, the classifier may be a software code program compiled according to a logical application process of the four-level fault classification management model (F4CM). Therefore, related application costs of the chip or other hardware do not need to be increased in design of the classifier.

According to the foregoing descriptions, the embodiment of the logical application of the four-level fault classification management model (F4CM) of this application is the low-cost and high-efficiency fault management system for functional safety of an automotive grade chip. By using a centralized, hierarchical, and fine-grained chip function fault management system, the fault management system can effectively detect and classify internal faults of the chip according to severity levels, to provide the system with accurate fault information, and ensure that the system software accurately locates and responds to various faults. Therefore, a fault detection load of the system software is reduced, reasonable fault response measures are taken in an effective and timely manner, and availability of the system is improved when a fault occurs.

FIG. 4 is a logical structural diagram of a fault controller according to an implementation of this application. A logical structure of the fault controller in FIG. 4 is designed according to a logical application process of the four-level fault classification management model (F4CM) in FIG. 3.

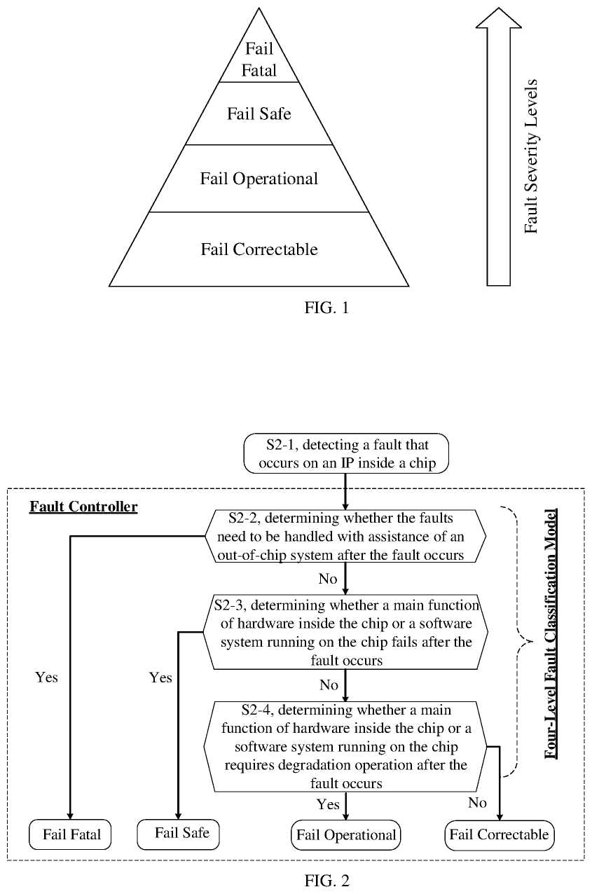

For example, in at least one embodiment of this application, the fault controller is responsible for collecting fault indicated signals that are sent by IPs (IP1, . . . , and IPn) inside the chip and all safety mechanisms in the chip system, and generates fault information based on pre-configuration and according to different scenarios where the chip is applied and the fault types. The fault information corresponds to the four-level fault classification management model (F4CM) shown in FIG. 1.

For example, in at least one embodiment of this application, the fault controller may be further responsible for collecting fault indicated signals that are sent by a static signal monitor of the fault controller, each IP inside the chip, and all safety mechanisms in the chip system.

For example, in at least one embodiment of this application, the fault controller may include four fault selections. A plurality of correspondences can be formed between generated fault information and an input fault indication signal by configuration of the fault selections. As shown in FIG. 4, the plurality of correspondences include a one-to-one (1 to 1) correspondence, a one-to-many (1 to N) correspondence, and/or a many-to-one (N to 1) correspondence, and N is a positive integer not smaller than 2. In this way, the fault management system having the controller in this embodiment can be adapted to different application scenarios and different functional safety level requirements.

As shown in FIG. 4, as an embodiment of a connection relationship, the fault controller is internally provided with four fault selections. The four fault selections respectively correspond to four types of faults: fail fatal, fail safe, fail operational, and fail correctable, and are respectively configured to selectively receive fault indicated signals sent by IPs (IP1, . . . , and IPn) inside the chip. The IPs (IP1, . . . , and IPn) inside the chip are respectively connected to the fault selections by using electric signals, such that the fault selections are able to receive fault indicated signals sent by the IPs.

In this embodiment, as shown in FIG. 4, a correspondence is established between each fault selection unit (for example, a fault selection unit 1) and the plurality of function modules IP1 to IPn through signal connection, and in this case, the correspondence is the foregoing many-to-one correspondence; a correspondence is established between each function module (for example, IP1) and the plurality of fault selections 1 to 4 to through signal connection, and in this case, the correspondence is the foregoing one-to-many correspondence; and a correspondence is established between one fault selection unit (for example, a fault selection unit 1) and a function module (for example, IP1) through signal connection, and in this case, the correspondence is the foregoing one-to-one correspondence. It should be noted that, in this embodiment of this application, the one-to-one, one-to-many, and many-to-one correspondences may exist independently or may coexist as shown in FIG. 4, which can be designed according to actual requirements and is not limited herein.

For example, in at least one embodiment of this application, the fault controller may be further externally provided with a software configuration module. The software configuration module is connected to each of the four fault selections by using an electric signal. The fault selections are pre-configured based on different scenarios where the chip is applied and the fault types, such that the fault selections can receive a fault indication signal sent by each IP inside the chip. The software configuration module may be further configured to perform real-time monitoring on a working state of the fault selections. When a fault or a logical error occurs on the fault selections, external monitoring and correction can be performed in a timely manner. After the software configuration module collects and determines the fault indication signal, fault information is generated.

During operation, the generated fault information may be sent to an internal module or external module (out-of-chip system, for example, a microcontroller) of the chip to perform the following handling operations: 1) outputting information about the fail operational and the fail correctable to a processor (CPU) inside the chip, to perform handling by software running on the chip; 2) outputting information about the fail safe to a system controller inside the chip, to perform automatic resetting and another necessary operation to enable the system to enter a safe state or resume operation; and 3) outputting information about the fail fatal to an out-of-chip system, where the out-of-chip system assists in performing resetting, powering-off, or other necessary operations.

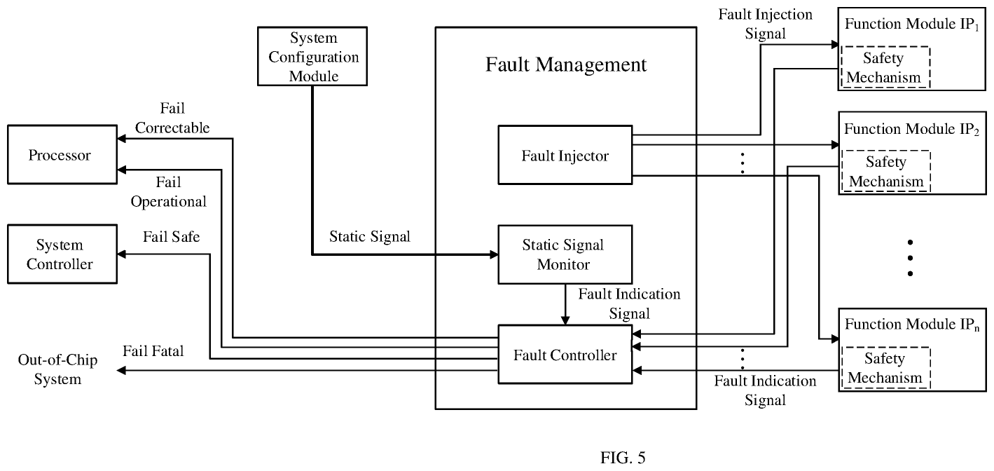

FIG. 5 is a logical structural diagram of a fault management system according to an implementation of this application. The fault management system shown in FIG. 5 is configured with the fault controller shown in FIG. 4, a static signal monitor, and a fault injector. A specific structure, function, and logical process of the fault controller are as described in the foregoing embodiments, and details are not repeated herein.

A structure, function, and logical process of the static signal monitor, the fault injector, and the fault management system are respectively described below in detail.

As shown in FIG. 5, the static signal monitor is responsible for performing, based on pre-configuration, real-time monitoring on a static signal generated by a system configure module inside the chip, and detecting failures caused by signal stuck-at faults. For example, the stuck-at faults are faults of type stuck-at 0 or stuck-at 1 well known in the art, and refers to a fault that a signal or pin in a circuit is unexpectedly fixed on logic 0 (stuck-at 0) or logic 1 (stuck-at 1) and cannot be changed. For details, see content in the website: http://web.stanford.edu/class/ee386/public/stuck_at_fault_6per_page. A fault indication signal generated by the static signal monitor is also output to the fault controller for classification and processing.

As shown in FIG. 5, functional safety not only requires that a safety mechanism be designed for monitoring a fault that may occur in a functional circuit, but also requires that the safety mechanism itself be detected to avoid a latent fault. The fault injector is configured to perform fault injection on an IP or a safety mechanism of the system by using error injection signals, detect a corresponding fault indication signal, and determine whether the safety mechanism itself fails. A fault injection function is classified into two types: hardware automatic fault injection and software controllable fault injection: (1) the hardware automatic fault injection function can be applied to a power-on process of the chip, and in this case, software on the CPU does not boot, and the hardware automatic fault injection and detection can ensure that the system runs in a safe environment after it boots; (2) the software controllable fault injection function can be applied to power-on, power-down, or operation processes of the chip, and in this case, the system can use different fault injection strategies for different safety mechanisms according to scenarios where the chip is applied and a fault tolerance time interval (FTTI), thereby improving application flexibility of the chip.

As shown in FIG. 5, in this embodiment of this application, a fault management device is designed. The fault management device may include a fault injector, a static signal monitor, and a fault controller. The fault injector may be electrically connected to each IP (IP1, . . . , or IPn) inside the chip. Each IP (IP1, . . . , or IPn) is internally configured with one or more safety mechanism(s). The fault injector performs fault injection on an IP or a safety mechanism of the system by using a fault injection signal, detects a corresponding fault indication signal, and determines whether the safety mechanism itself fails. The fault controller is electrically connected to each IP (IP1, . . . , or IPn), the static signal monitor, a processor (CPU), a system controller, and an out-of-chip system separately. The fault controller is internally configured with a fault classification management model; the static signal monitor is electrically connected to a system configure module inside the chip and configured to receive and perform real-time monitoring on static signals generated by the system configure module, and detects failures caused by signal stuck-at faults (stuck-at 0 or stuck-at 1).

In at least one embodiment of this application, the fault controller may be internally configured with a fault classification management model that uses a four-level fault classification management model (F4CM) designed in this application.

In at least one embodiment of this application, the four-level fault classification management model (F4CM) can be designed into four fault selections which respectively correspond to four types of faults: fail fatal, fail safe, fail operational, and fail correctable, and the four fault selections are respectively configured to selectively receive fault indicated signals sent by IPs (IP1, . . . , and IPn) inside the chip.

According to the foregoing embodiments, the fault management system for functional safety of an automotive grade chip provided in this application can ensure, by using a fine-grained fault classification system, that the system software accurately locates and responds to various faults, and that reasonable fault response measures are taken in an effective and timely manner, to improve availability of the system when a fault occurs. In addition, a fault detection load of the system software is reduced, facilitating implementation of fast, high-coverage, and individually configurable power-on and power-down self-tests by the chip. The correspondences between functional effects and technical means of the fault management system provided in the embodiments of this application is shown in Table 2 below.

TABLE 2
Correspondences between functional effects and technical means

| Functional Effect | Implementation Technical Means |
|---|---|
| Reducing a fault detection load of | The hardware automatically classifies |
| system software | faults based on configuration, and the |
| | software does not need to perform |
| | querying, determining, and |
| | classification-related operations. |
| Facilitating implementation of fast, | The hardware automatically classifies |
| high-coverage, and individually | faults based on configuration, and the |
| configurable power-on and power- | integrated fault injector can implement |
| down self-tests by the chip | self-tests conveniently. |
| Ensuring that the system software | The hardware automatically classifies |
| accurately locates and responds to | faults based on configuration. |
| various faults by using a fine- | |
| grained fault classification system | |
| Reasonable fault response | The hardware automatically classifies |
| measures being taken in an | faults according to configuration. |
| effective and timely manner | |
| Improving availability of the | The fault classification granularity is |
| system in the case of faults | fine, and the fail operational and fail |
| | correctable types can improve the |
| | availability. |

The foregoing descriptions are merely optional implementations of this application. Letters in parentheses in the text and those in figures of the accompanying drawings only represent name symbols of the modules or steps, and specific meanings thereof shall be subject to those described in the embodiments and Chinese meanings. It should be noted that, those skilled in the art may also make several improvements and modifications without departing from the principle of this application, and these improvements and modifications shall be included into the protection scope of this application.

What is claimed is:

1. A fault management system for functional safety of an automotive grade chip, comprising an out-of-chip system and an automotive-grade chip, wherein the automotive-grade chip comprises a fault management device, and the fault management device is configured with a fault classification management model.

2. The fault management system for functional safety of an automotive grade chip according to claim 1, wherein the fault management device is internally provided with the fault classification management model composed of four types of faults, and the four types of faults are divided in descending order of fault levels.

3. The fault management system for functional safety of an automotive grade chip according to claim 1, wherein the four types of faults are configured with the following rules:
type 1: a fault that needs to be handled with assistance of the out-of-chip system is classified as a fail fatal;
type 2: a fault that results in a failure of a main function is classified as a fail safe;
type 3: a fault handled through adaptive degradation operation is classified as a fail operational; and
type 4: a fault handled through automatic error correction operation is classified as a fail correctable.

4. The fault management system for functional safety of an automotive grade chip according to claim 3, wherein the four types of faults are further configured with the following rules:
rule 1: type 1>type 2>{type 3, type 4}, wherein {type 3, type 4} denotes a set of type 3 and type 4;
rule 2: type 3>type 4; and
rule 3: rule 1>rule 2.

5. The fault management system for functional safety of an automotive grade chip according to claim 3, wherein the automotive-grade chip comprises a processor, a system controller, a system configuration module and at least one function module which is located in the automotive-grade chip.

6. The fault management system for functional safety of an automotive grade chip according to claim 5, wherein the fault management device further comprises a fault injector, a static signal monitor and a fault controller;
the fault injector is electrically connected to each of the at least one function module located in the chip, and each of the at least one function module is internally configured with at least one safety mechanism;
the fault controller is electrically connected to the static signal monitor, the processor, the system controller, the out-of-chip system and the each of the at least one function module, and the fault controller is internally provided with the fault classification management model; and
the static signal monitor is electrically connected to the system configuration module located in the chip.

7. The fault management system for functional safety of an automotive grade chip according to claim 6, wherein the fault injector is configured to perform fault injection on the at least one safety mechanism by using a fault injection signal, detect a corresponding fault indication signal, and determine whether the at least one safety mechanism itself fails.

8. The fault management system for functional safety of an automotive grade chip according to claim 6, wherein the fault controller is responsible for collecting the fault indicated signal sent by a static signal monitor of the fault controller and the at least one safety mechanism.

9. The fault management system for functional safety of an automotive grade chip according to claim 8, wherein the fault controller sends generated fault information to the function module or the out-of-chip system, comprising:
outputting information classified as the fail operational and the fail correctable to the processor for processing;
outputting information classified as the fail safe to the system controller for automatic resetting, to enable the system to enter a safe state or resume operation; and
outputting information classified as the fail fatal to the out-of-chip system, wherein the out-of-chip system assists in performing resetting and powering-off operations.

10. The fault management system for functional safety of an automotive grade chip according to claim 9, wherein steps performed by the fault management device comprise:
step S2-1: receiving the fault indication signal sent from the at least one safety mechanism;
step S2-2: determining whether the faults need to be handled with the assistance of the out-of-chip system, comprising:
if a determining result is “yes”, determining the fault as the fail fatal, and performing resetting and powering-off operations with the assistance of the out-of-chip system; or
if a determining result is “no”, performing step S2-3;
step S2-3: determining whether a main function of hardware inside the chip or a software system running on the chip fails, comprising:
if a determining result is “yes”, determining the fault as the fail safe, and outputting the fault indication signal to the system controller to perform an automatic resetting operation, to enable the hardware or the software system to enter a safe state or resume operation; or
if a determining result is “no”, performing step S2-4;
step S2-4: determining whether a main function of the hardware or the software system requires degradation operation, wherein this step comprises:
if a determining result is “yes”, determining the fault as the fail operational, and outputting the fault indication signal to the processor to perform degradation operation; or
if a determining result is “no”, determining the fault as the fail correctable, and outputting the fault indication signal to the processor to perform automatic error correction by the at least one safety mechanism.

11. The fault management system for functional safety of an automotive grade chip according to claim 6, wherein the static signal monitor performs real-time monitoring on static signals generated by the system configuration module inside the chip, and detects failures caused by signal stuck-at faults.

12. The fault management system for functional safety of an automotive grade chip according to claim 11, wherein a fault indication signal generated by the static signal monitor is output to the fault controller for classification processing.

13. A fault management device for functional safety of an automotive grade chip, wherein the fault management device is applied to a fault management system, the fault management system comprises an out-of-chip system and an automotive-grade chip, and the fault management device is configured with a fault classification management model.

14. The fault management device for functional safety of an automotive grade chip according to claim 13, wherein the fault controller is internally provided with the fault classification management model composed of four types of faults divided in descending order of fault levels.

15. The fault management device for functional safety of an automotive grade chip according to claim 14, wherein the four types of faults are configured with the following rules:
type 1: a fault that needs to be handled with assistance of the out-of-chip system is classified as a fail fatal;
type 2: a fault that results in a failure of a main function is classified as fail safe;
type 3: a fault handled through adaptive degradation operation is classified as fail operational; and
type 4: a fault handled through automatic error correction operation is classified as fail correctable.

16. The fault management device for functional safety of an automotive grade chip according to claim 14, wherein the four types of faults are further configured with the following rules:
rule 1: type 1>type 2>{type 3, type 4}, wherein {type 3, type 4} denotes a set of type 3 and type 4;
rule 2: type 3>type 4; and
rule 3: rule 1>rule 2.

17. The fault management device for functional safety of an automotive grade chip according to claim 14, wherein the fault management device comprises a fault injector, a static signal monitor and a fault controller, wherein
the fault injector is electrically connected to each of the at least one function module inside the chip, and each of the at least one function module is internally configured with at least one safety mechanism;
the fault controller is electrically connected to the static signal monitor, a processor, a system controller, the out-of-chip system and each of the at least one function module, and the fault controller is internally provided with the fault classification management model; and
the static signal monitor is electrically connected to a system configuration module inside the chip.

18. The fault management device for functional safety of an automotive grade chip according toclaim 14, wherein the fault controller generates fault information according to different scenarios where the chip is applied and the four types of faults.

19. The fault management device for functional safety of an automotive grade chip according to claim 18, wherein a fault indication signal generated by the fault injector is input into the fault controller, the fault controller further comprises four fault selections, and a plurality of correspondences is able to be formed between the fault information and the fault indication signal by configuration of the fault selections.

20. The fault management device for functional safety of an automotive grade chip according to claim 19, wherein the plurality of correspondences comprise a one-to-one correspondence, a one-to-many correspondence, and/or a many-to-one correspondence, so as to be adapted to different application scenarios and different functional safety level requirements.
